(19) United States
(12) Patent Application Publication
(10) Pub. No.: US 2025/0374025 A1
(43) Pub. Date: Dec. 4, 2025

(54) HOME ROUTING PROTOCOL DATA UNIT SESSION WITH SESSION BREAKOUT AND MULTIPLE DOMAIN NAME SYSTEM RESOLVER INTERNET PROTOCOL ADDRESSES

(71) Applicant: QUALCOMM Incorporated, San Diego, CA (US)

(72) Inventors: Dario Serafino TONESI, San Diego, CA (US); Haris ZISIMOPOULOS, London (GB); Sebastian SPEICHER, Wallisellen (CH); Alan SOLOWAY, Frederick, CO (US); Sunghoon KIM, San Diego, CA (US); Tom CHIN, San Diego, CA (US)

(21) Appl. No.: 18/877,945

(22) PCT Filed: Jul. 25, 2023
(86) PCT No.: PCT/US2023/070917

§ 371 Date: Dec. 20, 2024

(30) Foreign Application Priority Data
Aug. 9, 2022 (GR) 20220100668

(51) Int. Cl. H04W 8/00; H04L 61/4511; H04W 84/04

(52) U.S. Cl. CPC H04W 8/005; H04L 61/4511; H04W 84/042

(57) ABSTRACT

Aspects relate to the management of multiple internet protocol (IP) addresses. In a first aspect, a UE receives a first IP address associated with one of a Home Edge Application Server Discovery Function (H-EASDF) server or a generic domain name system (DNS) server, and a second IP address associated with a V-EASDF server. The UE then transmits a DNS query associated with an edge computing application to one of the first or second IP address based on logic (e.g., instructions) residing in the UE. In another aspect, a core network node receives an IP address associated with a V-EASDF server, and transmits a communication to a user equipment that includes a first and second IP address. Here, the first IP address is associated with one of an H-EASDF server or a generic DNS server, whereas the second IP address is the IP address associated with the V-EASDF server.

### CROSS-REFERENCE TO RELATED APPLICATIONS

The present application for patent claims priority to pending Greek Provisional Patent Application no. 20220100668, filed Aug. 9, 2022, and assigned to the assignee hereof and hereby expressly incorporated by reference herein as if fully set forth below and for all applicable purposes.

### TECHNICAL FIELD

The technology discussed below relates generally to wireless communication and, more particularly, to facilitating a home routing (HR) protocol data unit (PDU) session with session breakout (SBO) via multiple internet protocol (IP) addresses.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems. These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

According to a first example, a user equipment (UE) is disclosed that includes a transceiver, a memory storing instructions, and a processor communicatively coupled to the transceiver and the memory. The processor is configured to receive a first internet protocol (IP) address and a second IP address. In this example, the first IP address is associated with one of a Home Edge Application Server Discovery Function (H-EASDF) server or a generic domain name system (DNS) server, whereas the second IP address is associated with a Visitor Edge Application Server Discovery Function (V-EASDF) server. The processor is further configured to transmit a DNS query associated with an edge computing application to one of the first IP address or the second IP address based on the instructions.

In other examples, a method for wireless communication in a UE is disclosed. The method includes receiving a first IP address and a second IP address. In this example, the first IP address is associated with one of an H-EASDF server or a generic DNS server, whereas the second IP address is associated with a V-EASDF server. The method further includes transmitting a DNS query associated with an edge computing application to one of the first IP address or the second IP address based on instructions included in the UE.

Another example provides a core network node within a mobile core network. The core network node includes a memory, and a processor coupled to the memory. The processor and the memory can be configured to receive an IP address associated with a V-EASDF server. The processor and the memory can be further configured to provide a communication to a UE that includes a first IP address and a second IP address. Here, the first IP address is associated with one of an H-EASDF server or a generic DNS server, whereas the second IP address is the IP address associated with the V-EASDF server.

According to yet another example, a method for wireless communications in a core network node is disclosed. The method includes receiving an IP address associated with a V-EASDF server, and further includes providing a communication to a UE that includes a first IP address and a second IP address. In this example, the first IP address is associated with one of an H-EASDF server or a generic DNS server, whereas the second IP address is the IP address associated with the V-EASDF server.

These and other aspects of the disclosure will become more fully understood upon a review of the detailed description, which follows. Other aspects, features, and examples of the present disclosure will become apparent to those of ordinary skill in the art, upon reviewing the following description of specific examples of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while examples may be discussed below as device, system, or method examples it should be understood that such examples can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5 is a block diagram illustrating various exemplar components of a 5G wireless communication system according to some aspects.

FIG. 6 is a block diagram illustrating an exemplary local breakout (LBO) protocol data unit (PDU) session that facilitates edge computing traffic according to some aspects.

FIG. 7 is a block diagram illustrating an exemplary home routed (HR) protocol data unit (PDU) session that facilitates non-edge computing traffic according to some aspects.

FIG. 8 is a block diagram illustrating an exemplary HR PDU session that includes a session breakout (SBO) in a Visited Public Land Mobile Network (V-PLMN) according to some aspects.

FIG. 9 is a signaling diagram illustrating a first exemplary routing of domain name system (DNS) queries according to some aspects.

FIG. 10 is a signaling diagram illustrating a second exemplary routing of DNS queries according to some aspects.

FIG. 11 is a signaling diagram illustrating an exemplary transmission of multiple internet protocol (IP) addresses to a user equipment (UE) according to some aspects.

FIG. 12 is a signaling diagram illustrating an exemplary routing of DNS queries via multiple IP addresses according to some aspects.

FIG. 13 is a block diagram illustrating an example of a hardware implementation for a user equipment (UE) employing a processing system according to some aspects.

FIG. 14 is a flow chart illustrating an example of a method for communication in a UE according to some aspects.

FIG. 15 is a block diagram illustrating an example of a hardware implementation for a core network node employing a processing system according to some aspects.

FIG. 16 is a flow chart illustrating a method for communication in a core network node according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form to avoid obscuring such concepts.

Aspects disclosed herein are directed towards a home routing (HR) protocol data unit (PDU) session with session breakout (SBO). In a particular aspect, a user equipment (UE) is provided with multiple edge application server discovery function (EASDF) internet protocol (IP) addresses to facilitate an HR PDU session with SBO. In some examples, a UE may then leverage such architecture to efficiently route domain name system (DNS) queries directly to multiple servers.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, examples and/or uses may come about via integrated chip examples and other non-module-component based devices (e.g., end-user devices, vehicles, communication devices, computing devices, industrial equipment, retail/purchasing devices, medical devices, artificial intelligence-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

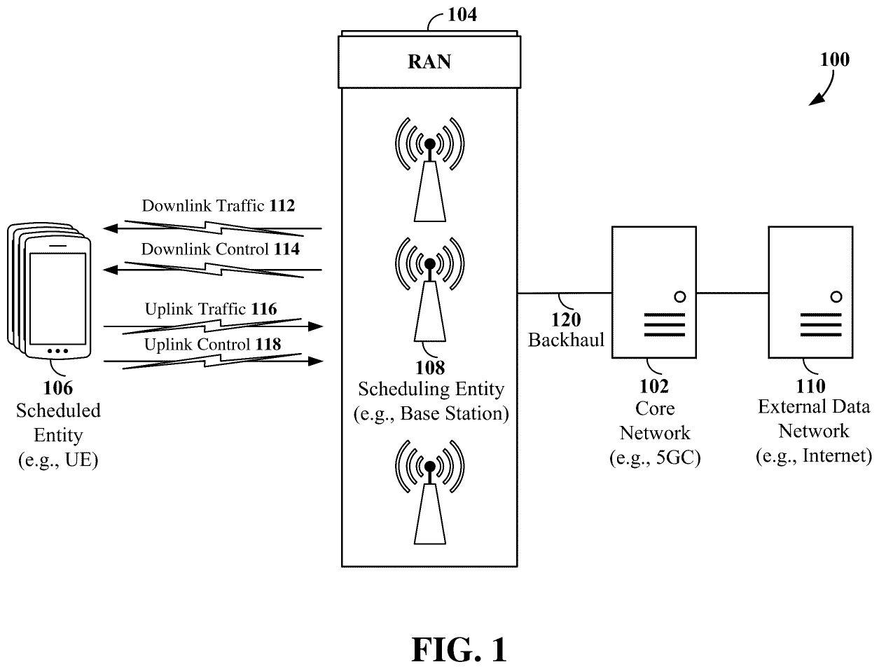

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station. In addition, one or more of the base stations may have a disaggregated configuration.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmissions. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

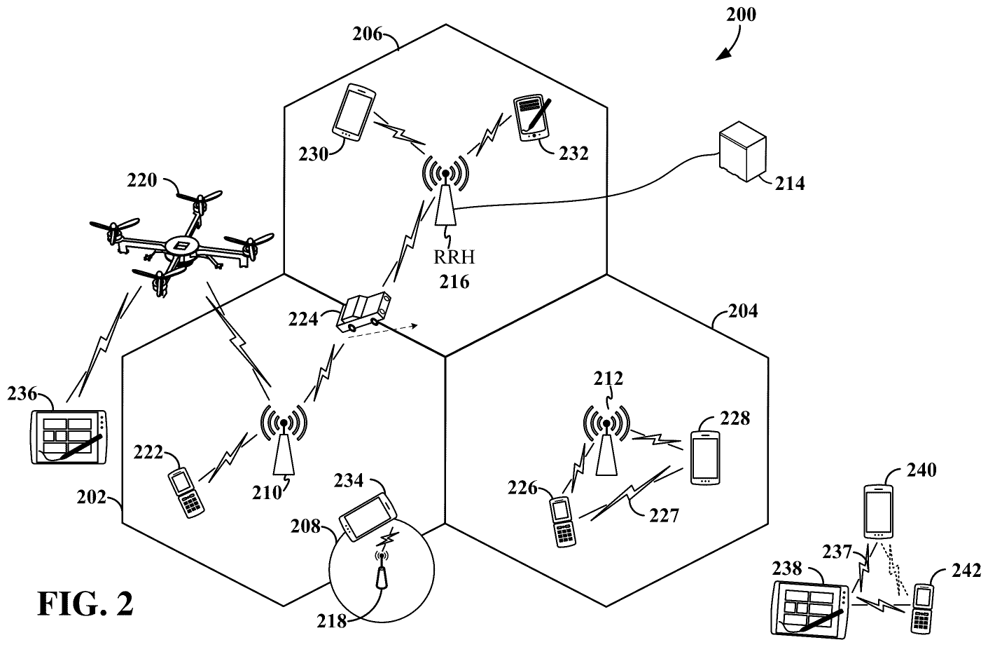

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

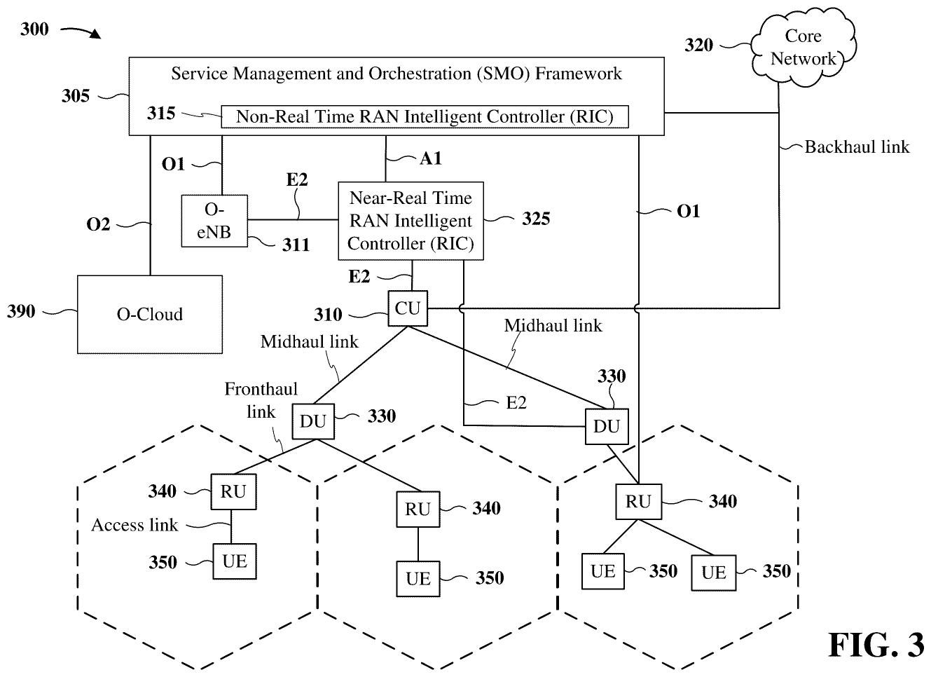

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

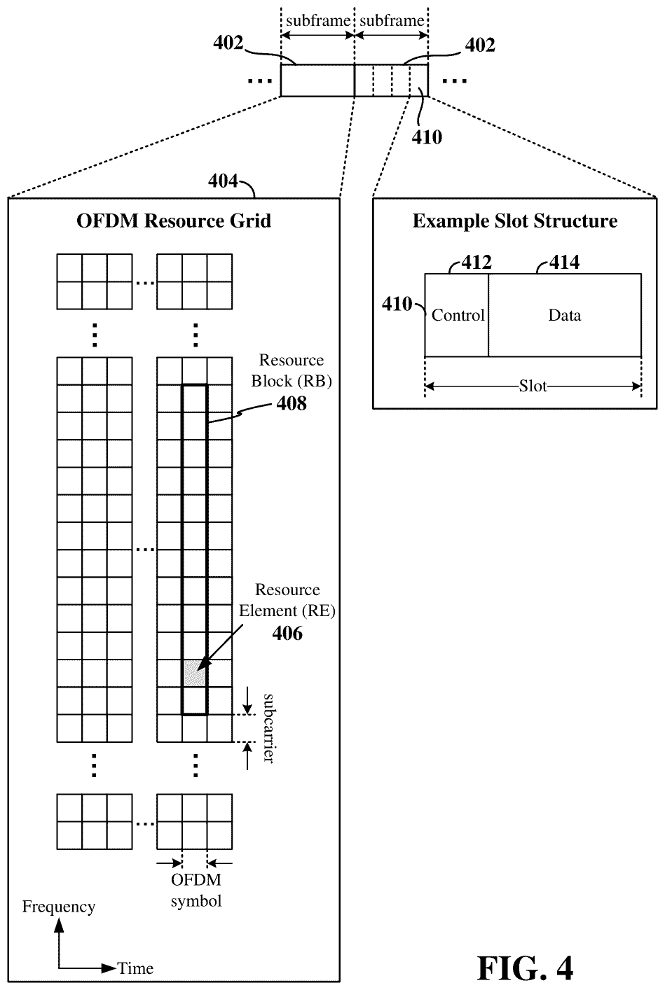

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

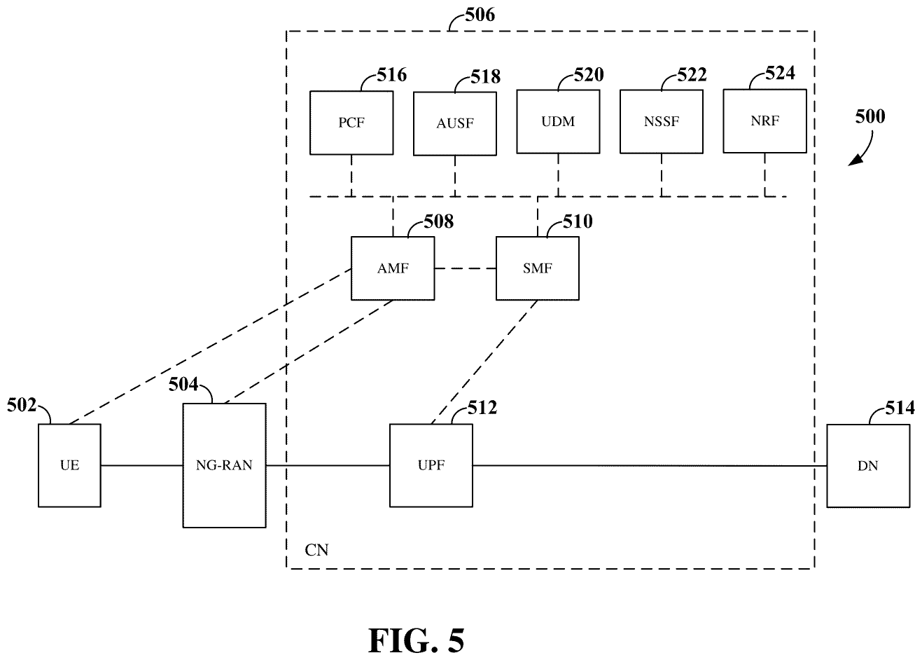

Referring now to FIG. 5, by way of example and without limitation, a block diagram illustrating an example of various components of a 5G wireless communication system (5GS) 500 is provided. In some examples, the 5GS 500 may correspond to the wireless communication system 100 described above and illustrated in FIG. 1. The 5GS 500 includes a user equipment (UE) 502, a NG-RAN 504, and a core network 506 (e.g., a 5G CN). The NG-RAN 504 may be a 5G RAN and correspond, for example, to the RAN 200 described above and illustrated in FIG. 2. In addition, the UE 502 may correspond to any of the UEs or other scheduled entities shown in FIG. 1 or 2. By virtue of the wireless communication system 500, the UE 502 may be enabled to carry out data communication with an external data network 514, such as (but not limited to) the Internet or an Ethernet network.

The core network 506 may include, for example, an access and mobility management function (AMF) 508, a session management function (SMF) 510, and a user plane function (UPF) 512. The AMF 508 and SMF 510 employ control plane (e.g., non-access stratum (NAS)) signaling to perform various functions related to mobility management and session management for the UE 502. For example, the AMF 508 provides connectivity, mobility management and authentication of the UE 502, while the SMF 510 provides session management of the UE 502 (e.g., processes signaling related to protocol data unit (PDU) sessions between the UE 502 and the external DN 514). The UPF 512 provides user plane connectivity to route 5G (NR) packets to/from the UE 502 via the NG-RAN 504.

As used herein, the term non-access stratum (NAS) may, for example, generally refer to protocols between the UE 502 and the core network 506 that are not terminated in the NG-RAN 504. In addition, the term access stratum may, for example, generally refer to a functional grouping consisting of the parts in the NG-RAN 504 and in the UE 502, and the protocols between these parts being specific to the access technique (i.e., the way the specific physical media between the UE 502 and the NG-RAN 504 is used to carry information).

The core network 506 may further include other functions, such as a policy control function (PCF) 516, authentication server function (AUSF) 518, unified data management (UDM) 520, network slice selection function (NSSF) 522, a network repository function (NRF) 524, and other functions (not illustrated, for simplicity). The PCF 516 provides policy information (e.g., rules) for control plane functions, such as network slicing, roaming, and mobility management. In addition, the PCF 516 supports 5G quality of service (QoS) policies, network slice policies, and other types of policies. The AUSF 518 performs authentication of UEs 502. The UDM 520 facilitates generation of authentication and key agreement (AKA) credentials, performs user identification and manages subscription information and UE context. The NSSF 522 redirects traffic to a network slice. Network slices may be defined, for example, for different classes of subscribers or use cases, such as smart home, Internet of Things (IoT), connected car, smart energy grid, etc. Each use case may receive a unique set of optimized resources and network topology (e.g., a network slice) to meet the connectivity, speed, power, and capacity requirements of the use case. The NRF 524 is a central repository for all of the 5G network functions (NFs) in the wireless communication system 500. The NRF 524 enables NFs to register and discover one another. In addition, the NRF 524 supports a 5G service-based architecture (SBA).

To establish a connection to the core network 506 (e.g., a 5G core network) via the NG-RAN 504, the UE 502 may transmit a registration request to the AMF 508 core network 506 via the NG-RAN 504. The AMF 508 may then initiate non access stratum (NAS) level authentication between the UE 502 and the core network 506 (e.g., via the AUSF 518 and UDM 520). The AMF 508 may then retrieve mobility subscription data, SMF selection data, and UE context and communicate with the PCF 516 for policy association for the UE 502. The AMF 508 may then send a NAS secure registration accept message to the UE 502 to complete the registration.

Once the UE 502 has registered with the core network 506, the UE 502 may transmit a PDU session establishment request to establish one or more PDU sessions to the core network 506 via the NG-RAN 504. The AMF 508 and SMF 510 may process the PDU session establishment request and establish a data network session (DNS) between the UE 502 and the external DN 514 via the UPF 512. A DNS may include one or more sessions (e.g., data sessions or data flows) and may be served by multiple UPFs 512 (only one of which is shown for convenience). Examples of data flows include, but are not limited to, IP flows, Ethernet flows and unstructured data flows.

In some examples, each PDU session may be associated with a respective network slice. The 5GS 500 may allow for multiple instances of a network slice (also referred to as network slice instances). For example, a network slice instance may include a set of network function instances and resources (e.g., compute, storage, and networking resources) which form a network slice. Each network slice instance may provide the network characteristics associated with a service supported by the 5GS 500.

In the 5GS 500, network slice selection assistance information (NSSAI) may refer to a collection of identifiers for network slices, where each identifier is referred to as single-network slice selection assistance information (S-NSSAI). In some examples, an S-NSSAI identity may include a slice/service type (SST) and a slice differentiator (SD). The SST may indicate the expected network slice behavior in terms of features and services, and the SD may be optionally used to differentiate among multiple network slices of the same SST. An S-NSSAI may have standard values or non-standard values. For example, an S-NSSAI with a standard value may mean that the S-NSSAI includes an SST with a standardized SST value. In one example, an SST value 1 may be associated with an eMBB network slice type, which may be suitable for handling 5G enhanced mobile broadband. In another example, an SST value 2 may be associated with a URLLC network slice type, which may be suitable for handling ultra-reliable low latency communications. In yet another example, an SST value 3 may be associated with an MIoT network slice type, which may be suitable for handling of massive IoT.

The UE 502 may request one or more S-NSSAIs when the UE 502 registers with the core network 506. For example, the UE 502 can transmit a radio resource control (RRC) message (Msg5) including an access stratum (AS)-requested NSSAI and a NAS registration request including the requested NSSAI. Here, an NSSAI includes a set of one or more S-NSSAI(s) Thus, the requested NSSAI may include, for example, the S-NSSAI(s) corresponding to the slice(s) to which the UE 502 is requesting to register. In some examples, the requested S-NSSAI(s) included in Msg5 may be a subset of the requested S-NSSAI(s) included in the NAS registration request message since Msg5 does not include security protection. The NG-RAN 504 can route the NAS registration request to the AMF 508, which may be selected using the requested NSSAI obtained from the AS message in Msg5. If the NG-RAN 504 is unable to select an AMF based on the requested NSSAI, the NG-RAN 504 may route the NAS registration request to an AMF from a set of default AMFs.

The AMF 508 may then respond with a NAS registration accept message including a list of allowed S-NSSAIs (allowed-NSSAI) and a list of rejected S-NSSAIs (rejected-NSSAI). The allowed NSSAI may include a minimum common set of the requested NSSAI (or default S-NSSAI(s) if no valid S-NSSAI is requested), the subscribed NSSAI, and the NSSAI supported by the current tracking area (TA) of the UE 502. In general, once a network slice is created, the slice is valid within a registration area (RA), which includes one or more tracking areas (TAs).

The AMF 508 verifies whether the S-NSSAI(s) in the requested NSSAI are permitted based on the subscribed S-NSSAIs in the UE context. In some examples, the AMF 508 may query the NSSF 522, with the requested NSSAI, the subscribed S-NSSAIs, the public land mobile network (PLMN) identifier (ID) of the NG-RAN 504, and other suitable information to retrieve the network slice instances (NSIs) to serve the UE 502. The AMF 508 may then include the permitted S-NSSAIs in the allowed-NSSAI and the not permitted S-NSSAIs in the rejected-NSSAI in the NAS registration accept message to the NG-RAN 504. The NG-RAN 504 may then forward the NAS registration accept message to the UE 502 within an RRC reconfiguration message to establish an RRC connection and a signaling radio bearer (SRB). A SRB is a logical communication channel on L2 and higher layers for the transfer of control information between the UE 502 and the NG-RAN 504. For example, the SRB may carry a dedicated control channel (DCCH) including physical (PHY) layer, medium access control (MAC) layer, and other access layer control information.

The UE 502 may then establish a PDU session associated with an S-NSSAI within the allowed-NSSAI. For example, the UE 502 may transmit a PDU session establishment request over NAS signaling to the core network 506 (e.g., the AMF 508). The PDU session establishment request may include the S-NSSAI and a data network name (DNN) of a DN 514 to which the PDU session is intended. SMF 510 discovery and selection within the selected NSI indicated by the S-NSSAI may then be initiated by the AMF 508. In some examples, the NRF 524 may assist the discovery and selection tasks of the required network functions for the selected NSI. For example, the AMF 508 may query the NRF 524 to select an SMF 510 in a NSI based on S-NSSAI, DNN and other information, e.g., UE subscription and local operator policies. The selected SMF 510 may then establish the PDU Session, which may include one or more quality of service (QoS) flows, with the DN 514 based on S-NSSAI and DNN. At the NAS level, a QoS flow is characterized by a QoS profile provided by the 5GC 506 to NG-RAN 504 and QoS rule(s) provided by 5GC 506 to the UE 502. The QoS profile is used by NG-RAN 504 to determine the treatment on the radio interface while the QoS rules dictate the mapping between uplink user plane traffic and QoS flows to the UE 502.

Upon establishing the PDU session, the NG-RAN 504 establishes one or more Data Radio Bearers (DRB) for the PDU Session. A DRB is a logical communication on L2 and higher layers for the transfer of data for the PDU session. For example, a DRB carries dedicated traffic channel (DTCH) data for a PDU session. A DRB may be established using a radio bearer (RB) setup procedure on the SRB. The NG-RAN 504 can map packets belonging to different PDU sessions to different DRBs. NAS level packet filters in the UE 502 and in the 5GC 506 can further associate uplink and downlink packets with QoS, and AS level mapping rules in the UE 502 and in the NG-RAN 504 can associate uplink and downlink QoS Flows with DRBs.

As previously mentioned, aspects disclosed herein are directed towards utilizing an HR PDU session with SBO to efficiently route DNS queries transmitted by a UE. Here, it should be noted that a DNS query (also known as a DNS request) generally refers to a demand for information sent from a user's computer (DNS client) to a DNS server. In most cases a DNS request is sent, to ask for the IP address associated with a domain name. An attempt to reach a domain, is actually a DNS client querying the DNS servers to get the IP address, related to that domain.

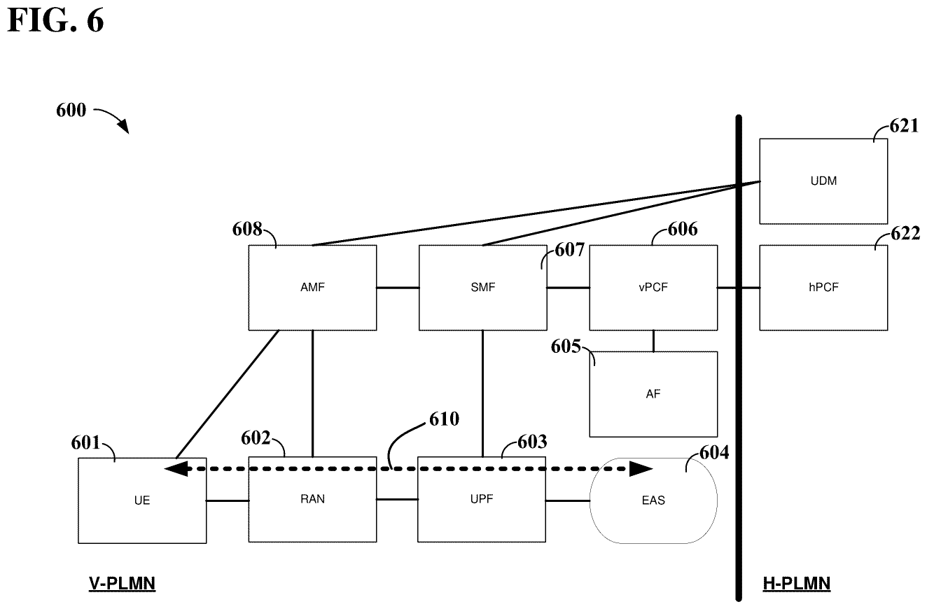

The architecture disclosed herein may be beneficial for UEs roaming in a visited public land mobile network (V-PLMN), wherein the UE may be transmitting both edge computing (EC) traffic and non-EC traffic. FIG. 6 is a block diagram illustrating an exemplary local breakout (LBO) PDU session in which architecture 600 facilitates EC traffic 610. As illustrated, on the V-PLMN side, architecture 600 may include UE 601, RAN 602, User Plane Function (UPF) 603, Edge Application Servers (EAS) 604, Application Function (AF) 605, Visitor Policy Control Function (vPCF) 606, Session Management Function (SMF) 607, and Access and Mobility Management Function (AMF) 608. On the H-PLMN side, architecture 600 may include Unified Data Management (UDM) 621 and Home Policy Control Function (hPCF) 622.

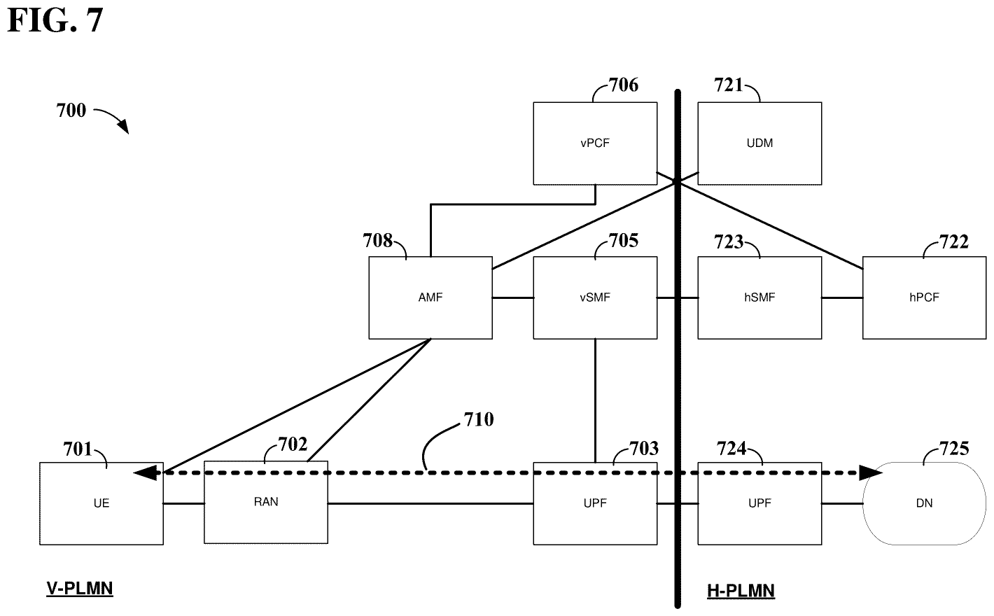

FIG. 7 is a block diagram illustrating an exemplary HR PDU session in which architecture 700 facilitates non-EC traffic 710. As illustrated, on the V-PLMN side, architecture 700 may include UE 701, RAN 702, UPF 703, AF 705, vPCF 706, SMF 707, and AMF 708. On the H-PLMN side, architecture 700 may include UDM 721, hPCF 722, Home SMF (hSMF) 723, UPF 724, and Data Network (DN) 725.

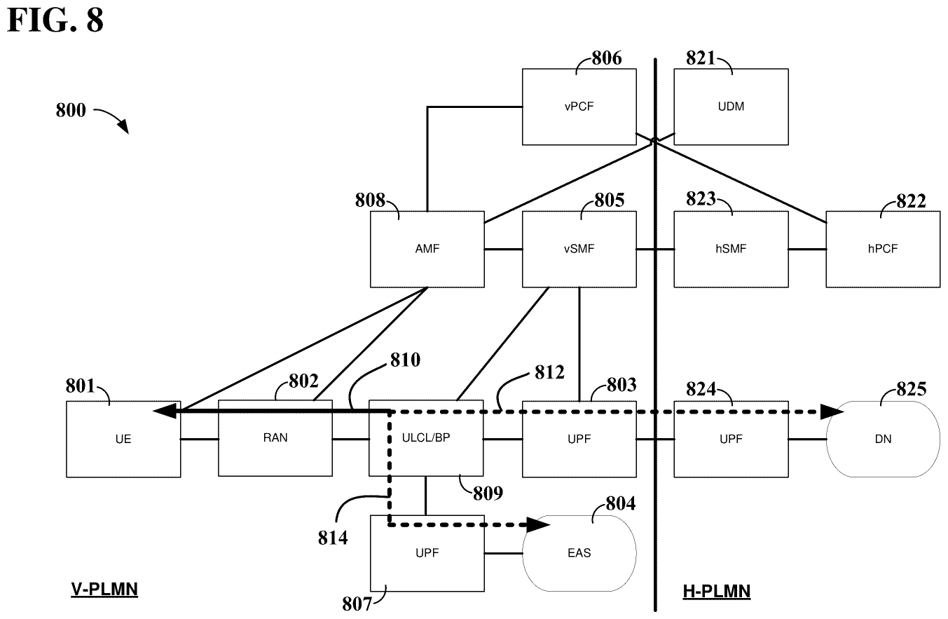

However, rather than using one communication protocol for EC traffic, and a different communication protocol for non-EC traffic, in some examples, a single HR PDU session with an SBO can be used. Indeed, as illustrated in FIG. 8. architecture 800 supports routing all traffic 810 via a single HR PDU session with an SBO. As illustrated, on the V-PLMN side, architecture 800 may include UE 801, RAN 802, UPF 803, vSMF 805, vPCF 806, UPF 807, AMF 808, and Uplink Classifier (ULCL)/Branching Point (BP) 809. On the H-PLMN side, architecture 700 may include UDM 721, hPCF 722, Home SMF (hSMF) 723, UPF 724, and Data Network (DN) 725. Here, the UE may use the HR PDU session for generic (i.e., non-EC) traffic 812, while directing the EC traffic 814 to a local edge application server (EAS) in the V-PLMN via a ULCL/Branching Point (BP) inserted for the SBO, as shown.

Here, it should be noted that a first scenario may occur in which the H-PLMN knows the EAS deployment information (EDI) of EAS' in the V-PLMN, as well as a second scenario in which the H-PLMN does not know the EDI of EAS' in the V-PLMN. It should be further noted that various solutions for how to discover the V-EAS have been contemplated.

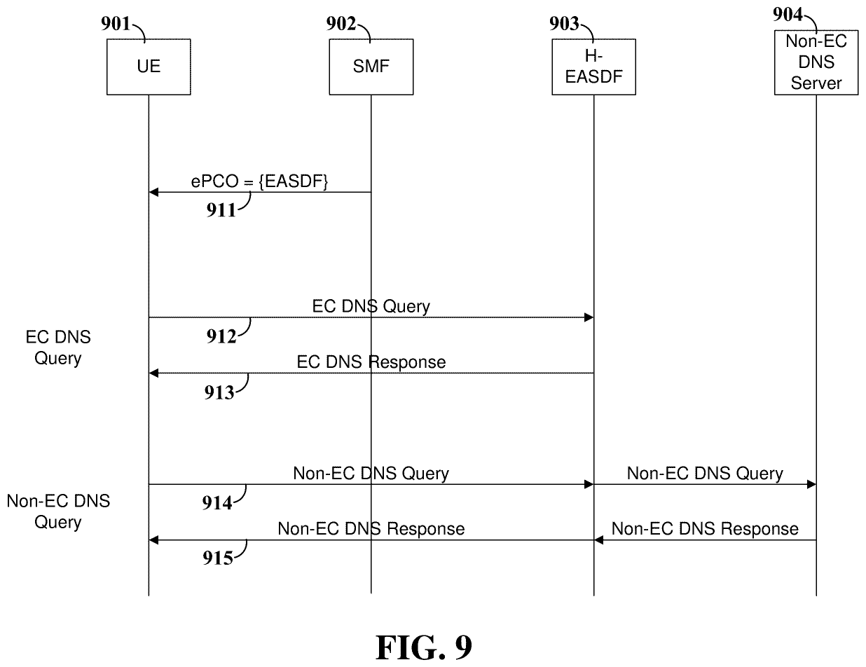

Referring next to FIG. 9, a signaling diagram is provided illustrating an exemplary routing of domain name system (DNS) queries in accordance with a first solution for discovering the V-EAS. As illustrated, in some examples, each of UE 901, SMF 902, H-EASDF 903, and non-EC DNS server 904 may be communicatively coupled and configured to communicate signals 911-915. In this solution, H-EASDF and H-SMF obtain ECS option/local DNS from V-SMF during EAS discovery. Furthermore, no V-EASDF is used, and all DNS queries are sent by the UE to H-EASDF, wherein the H-EASDF resolves DNS queries including fully qualified domain names (FQDNs) deployed in the V-PLMN based on the ECS option/local DNS. Also, in circumstances where the H-PLMN knows the EDI of EAS' in the V-PLMN, different FQDNs may use different ECS option/local DNS server. However, if the H-PLMN does not know the EDI of EAS' in the V-PLMN, all FQDNs may use the same ECS option/local DNS server.

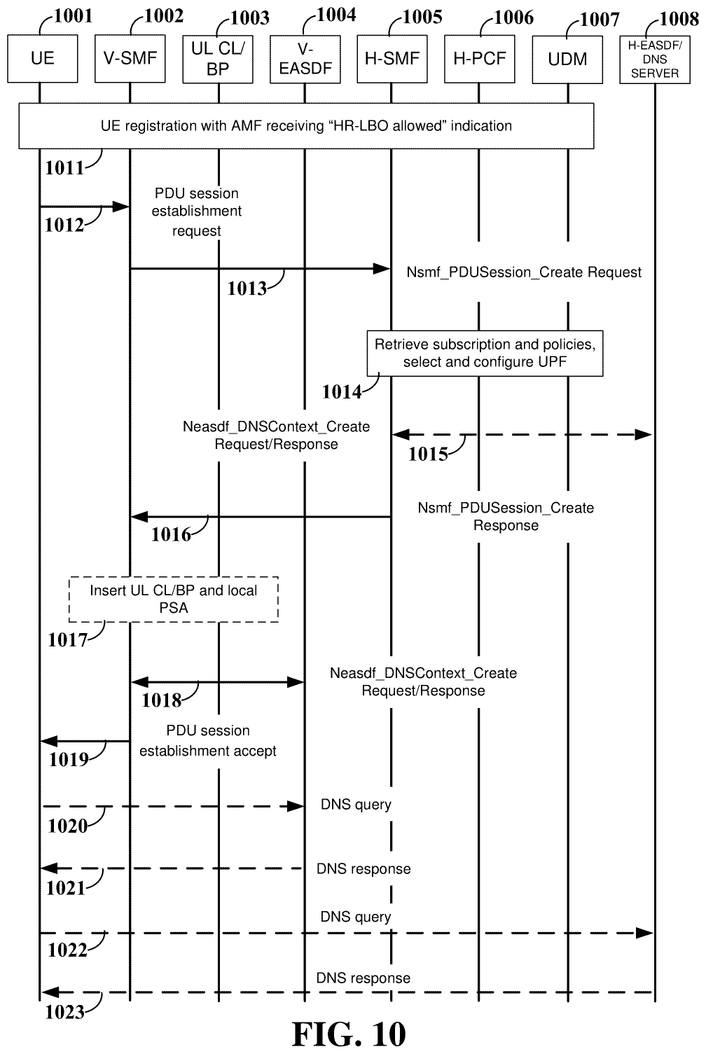

Referring next to FIG. 10, a signaling diagram is provided illustrating an exemplary routing of DNS queries in accordance with a second solution for discovering the V-EAS. As illustrated, in some examples, each of UE 1001, vSMF 1002, ULCL/BP 1003, V-EASDF 1004, H-SMF 1005, H-PCF 1006, UDM 1007, and H-EASDF/DNS server 1008 may be communicatively coupled and configured to communicate signals 1011-1023. For this solution, in some examples, the V-SMF provides the H-PLMN with the V-EASDF's IP address. With respect to determining which EASDF is used (i.e., V-EASDF vs. H-EASDF), two options are considered. In a first option, the H-SMF sends H-EASDF's IP address to the V-SMF (i.e., so that V-EASDF is configured to forward unresolvable DNS queries to the H-EASDF), and sends V-EASDF's address to the UE in an Extended Protocol Configuration Options (ePCO) communication. In a second option, the H-SMF sends H-EASDF's address to the UE in an ePCO communication, wherein the H-EASDF is configured to forward DNS queries to V-EASDF in cases where applications need to discover the V-EAS.

It should be noted that the two solutions shown and described with respect to FIGS. 9 and 10 may suffer from various limitations. For instance, in the first solution, all DNS queries are sent to the H-EASDF, and in the second solution, the DNS queries of the PDU Session are either all sent to the H-EASDF (and then the ones for EC are forwarded to the V-EASDF) or all sent to the V-EASDF (and then forwarded to the H-EASDF). In both solutions, the UE may not be able to differentiate to which EASDF the DNS queries need to be sent, which can lead to suboptimal performance when it comes to DNS query resolutions.

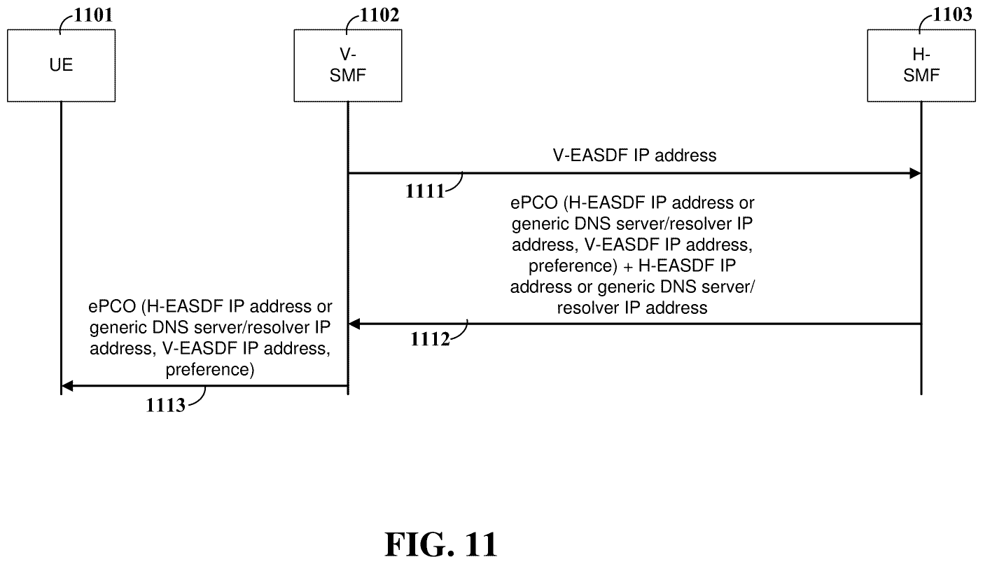

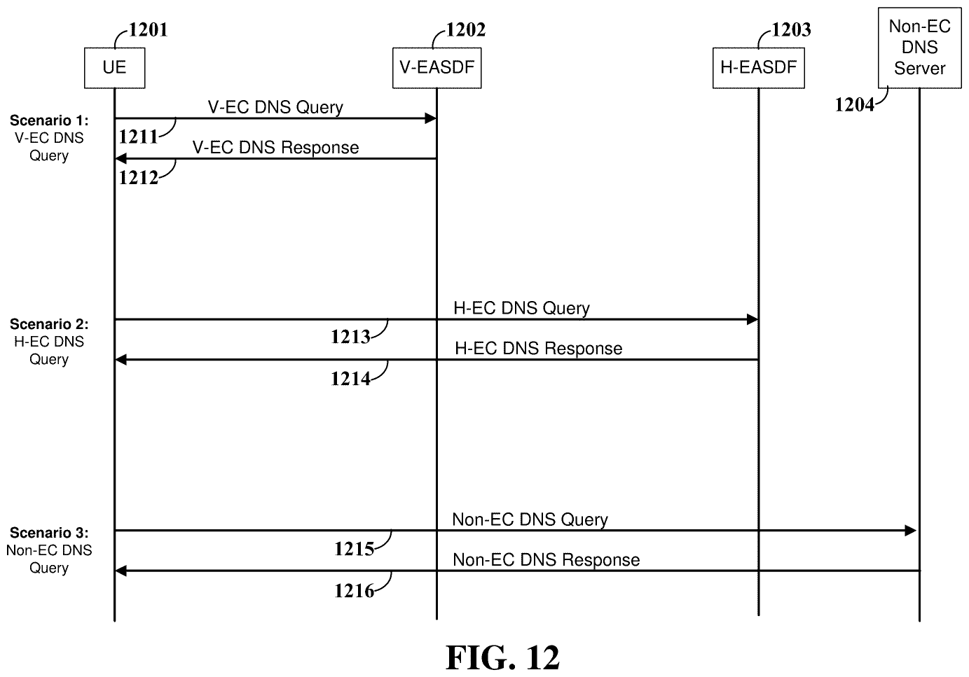

To overcome these limitations, various aspects are related to enhancements to the PDU session establishment procedure for an HR session, as illustrated in FIGS. 11-12. Here, it is assumed that the V-SMF provides the V-EASDF IP address to the H-SMF similar to the second solution described above. It is also assumed that the H-SMF provides the V-SMF with the IP address of the H-EASDF so that the V-EASDF is configured to forward to the H-EASDF the unresolvable DNS queries.

FIG. 11 is a signaling diagram illustrating an exemplary transmission of multiple EASDF IP addresses to a UE according to some aspects. As illustrated, in some examples, each of UE 1101, V-SMF 1102, and H-SMF 1103 may be communicatively coupled and configured to communicate signals 1111-1113. In a particular aspect, in some examples, the signaling illustrated in FIG. 11 occurs during the establishment or during the modification of an HR PDU session with SBO in a V-PLMN. As illustrated in FIG. 11, the H-SMF 1103 provides to the UE 1101 both the H-EASDF's IP address and the V-EASDF's IP address. For example, the H-EASDF IP address and the V-EASDF IP address can both be included in an ePCO communication, in which the ePCO is sent to the UE 1101 via the V-SMF 1102, and the contents of the ePCO are not visible to the V-SMF 1101. In some examples, the H-SMF 1103 sends the V-SMF 1102 the IP address of the H-EASDF and the ePCO, which itself also includes the IP address of the H-EASDF.

In some examples, variations may exist in the information included in the ePCO sent to the UE 1101 via the V-SMF 1102. For instance, rather than including the IP address of the H-EASDF, the ePCO communication may include the IP address of a generic DNS server/resolver.

In other aspects, the H-SMF 1103 may optionally indicate a preference of which EASDF should be used (e.g., it can indicate H-EASDF/generic DNS resolver preferred, V-EASDF preferred, or no preference). However, such preference may not obligate the UE 1101 to select the preferred EASDF indicated. In some examples, the UE 1101 may use the preference, in addition various other factors, when selecting which EASDF should be used. For example, the UE 1101 may include modem/edge DNC client (EDC) functionality to select which EASDF to use for resolving a DNS query based on internal/local logic (e.g., instructions stored within the UE 1101) and on the HPLMN preference (if indicated). In other examples, the selection may be based on internal/local logic (e.g., instructions) within the UE 1101 (e.g., local logic indicating whether an application is not allowed to use EC roaming or an application does not prefer to use EC roaming) and the preference indicated by the H-PLMN, if any. Alternatively, or in addition, the UE/EDC functionality may decide which EASDF to use based on load conditions (e.g., based on a number of applications running on the UE 1101).

FIG. 12 is a signaling diagram illustrating an exemplary routing of DNS queries via multiple EASDF IP addresses according to some aspects. As illustrated, in some examples, each of UE 1201, V-EASDF 1202, H-EASDF 1203, and non-EC DNS server 1204 may be communicatively coupled and configured to communicate signals 1211-1216. As illustrated, at least three scenarios are contemplated in which DNS queries are routed directly to either the V-EASDF, the H-EASDF, or a non-EC DNS server, where the selection of where to route any particular DNS query may be based on any combination of the aforementioned factors. Namely, in the first scenario, a DNS query for Edge Computing traffic meant for the Visited PLMN is processed via an exchange of signals 1211-1212 between UE 1201 and V-EASDF 1202. In the second scenario, a DNS query for Edge Computing traffic meant for the Home PLMN is processed via an exchange of signals 1213-1214 between UE 1201 and H-EASDF 1203. And in the third scenario, a DNS query for non-Edge Computing traffic is processed via an exchange of signals 1215-1216 between UE 1201 and non-EC DNS server 1204.

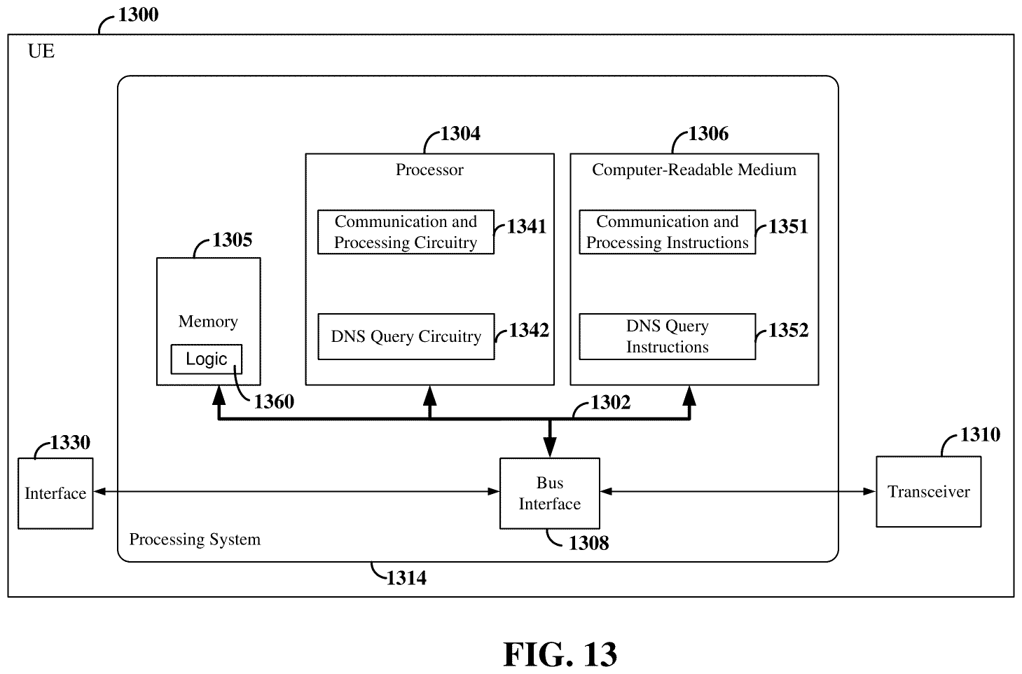

FIG. 13 is a block diagram conceptually illustrating an example of a hardware implementation for a user equipment (UE) 1300 employing a processing system 1314 according to some aspects of the disclosure. In accordance with various aspects of the disclosure, an element, or any portion of an element, or any combination of elements may be implemented with a processing system 1314 that includes one or more processors 1304. In some implementations, the UE 1300 may correspond to any of the UEs or scheduled entities shown in any of the FIGs. included herein.

The UE 1300 may be implemented with a processing system 1314 that includes one or more processors 1304. Examples of processors 1304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1300 may be configured to perform any one or more of the functions described herein. That is, the processor 1304, as utilized in a UE 1300, may be used to implement any one or more of the processes and procedures described below.

In this example, the processing system 1314 may be implemented with a bus architecture, represented generally by the bus 1302. The bus 1302 may include any number of interconnecting buses and bridges depending on the specific application of the processing system 1314 and the overall design constraints. The bus 1302 communicatively couples together various circuits including one or more processors (represented generally by the processor 1304), a memory 1305, and computer-readable media (represented generally by the computer-readable medium 1306). The bus 1302 may also link various other circuits such as timing sources, peripherals, voltage regulators, and power management circuits, which are well known in the art, and therefore, will not be described any further. A bus interface 1308 provides an interface between the bus 1302 and a transceiver 1310 and between the bus 1302 and an interface 1330. The transceiver 1310 provides a communication interface or means for communicating with various other apparatus over a wireless transmission medium. In some examples, the wireless communication device may include two or more transceivers 1310, each configured to communicate with a respective network type (e.g., terrestrial or non-terrestrial). At least one interface 1330 (e.g., a network interface and/or a user interface) provides a communication interface or means of communicating with various other apparatus and devices (e.g., other devices housed within the same apparatus as the UE 1300 or an external apparatus) over an internal bus or via external transmission medium, such as an Ethernet cable.

The processor 1304 is responsible for managing the bus 1302 and general processing, including the execution of software stored on the computer-readable medium 1306. The software, when executed by the processor 1304, causes the processing system 1314 to perform the various functions described below for any particular apparatus. The computer-readable medium 1306 and the memory 1305 may also be used for storing data that is manipulated by the processor 1304 when executing software.

One or more processors 1304 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1306.

The computer-readable medium 1306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1306 may reside in the processing system 1314, external to the processing system 1314, or distributed across multiple entities including the processing system 1314. The computer-readable medium 1306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

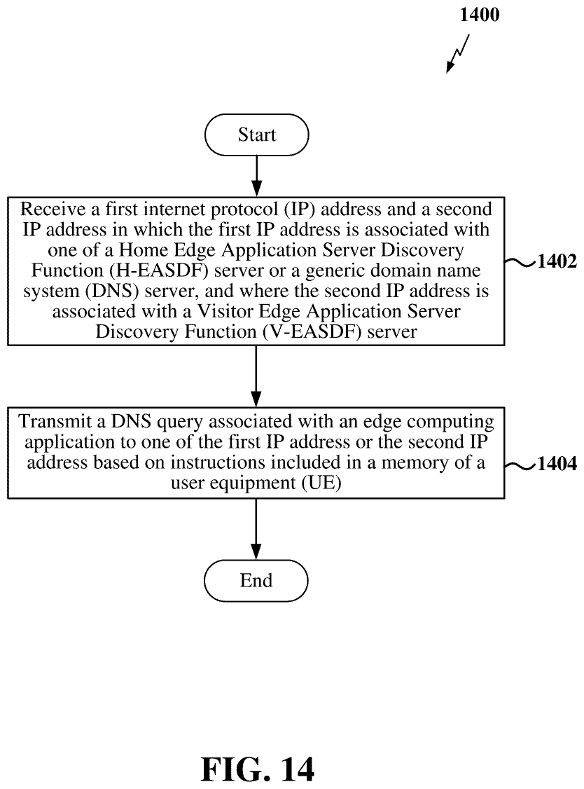

The UE 1300 may be configured to perform any one or more of the operations described herein (e.g., as described above in conjunction with FIGS. 6-12 and as described below in conjunction with FIG. 14). In some aspects of the disclosure, the processor 1304, as utilized in the UE 1300, may include circuitry configured for various functions.

In one aspect, the processor 1304 may include a communication and processing circuitry 1341. The communication and processing circuitry 1341 may include one or more hardware components that provide the physical structure that performs various processes related to wireless communication (e.g., signal reception and/or signal transmission) as described herein. The communication and processing circuitry 1341 may further include one or more hardware components that provide the physical structure that performs various processes related to signal processing (e.g., processing a received signal and/or processing a signal for transmission) as described herein. In some examples, the communication and processing circuitry 1341 may include two or more transmit/receive chains. The communication and processing circuitry 1341 may further be configured to execute communication and processing instructions (e.g., software) 1351 included on the computer-readable medium 1306 to implement one or more functions described herein.

The processor 1304 also includes DNS query circuitry 1342 configured to generate DNS queries. Moreover, the DNS query circuitry 1342, in conjunction with communication and processing circuitry 1341 and/or the transceiver 1310, may send DNS queries directly to any of various entities (e.g., a V-EASDF, an H-EASDF, or generic DNS server/resolver), and subsequently receive DNS query responses from those entities. The DNS query circuitry 1342 may further be configured to execute DNS query instructions 1352 included on the computer-readable medium 1306 to implement one or more functions described herein.

In further aspects, the processor 1304 in conjunction with the communication and processing circuitry 1341 and/or the DNS query circuitry 1342 may be configured to perform various acts. For instance, the processor 1304 in conjunction with the communication and processing circuitry 1341 and/or the DNS query circuitry 1342 may be configured to receive a first IP address and a second IP address, where the first IP address is associated with one of an H-EASDF server or a generic DNS server, and the second IP address is associated with a V-EASDF server. and transmit a DNS query associated with an edge computing application to one of the first IP address or the second IP address based on logic 1360 residing on the UE 1300.

In another aspect, the processor 1304 in conjunction with the communication and processing circuitry 1341 and/or the DNS query circuitry 1342 may be further configured to receive a preference indicating which of the first IP address or the second IP address is preferred by a network, where the logic residing on the UE is configured to select one of the first IP address or the second IP address based in part on the preference.

Various aspects of the logic residing in UE 1300 are also contemplated. For instance, the logic residing in the UE 1300 may be configured to select one of the first IP address or the second IP address based in part on whether the edge computing application is configured to enable edge computing roaming and/or whether the edge computing application indicates a preference to use edge computing roaming. The logic residing in the UE 1300 may also be configured to select one of the first IP address or the second IP address based in part on load conditions of the UE 1300 (e.g., where the load conditions of the UE 1300 include a total number of applications running on the UE 1300).

In another aspect disclosed herein, in some examples, the processor 1304 in conjunction with the communication and processing circuitry 1341 and/or the DNS query circuitry 1342 may be configured to communicate in various ways to different entities. For instance, in some examples, the processor 1304 in conjunction with the communication and processing circuitry 1341 and/or the DNS query circuitry 1342 may be configured to receive the first IP address and the second IP address during an establishment of HR PDU session, and wherein the HR PDU session comprises an SBO in a V-PLMN. It is further contemplated that the processor 1304 in conjunction with the communication and processing circuitry 1341 and/or the DNS query circuitry 1342 may be configured to receive the first IP address and the second IP address within an ePCO communication (e.g., where the ePCO communication is received from an H-SMF via a V-SMF).

FIG. 14 is a flow chart illustrating an example wireless communication method 1400 implemented by a UE according to some aspects of the disclosure. As described herein, some or all illustrated features may be omitted in a particular implementation within the scope of the present disclosure, and some illustrated features may not be required for implementation of all examples. In some examples, the method 1400 may be carried out by the UE 1300 illustrated in FIG. 13. In some examples, the method 1400 may be carried out by any suitable apparatus or means for carrying out the functions or algorithm described below.

At block 1402, the UE may receive a first IP address and a second IP address in which the first IP address is associated with one of a H-EASDF server or a generic DNS server, and where the second IP address is associated with a V-EASDF server. In an aspect, the processes of block 1402 may be implemented by a means for receiving a first IP address and a second IP address, which may be implemented by processor 1304, communication and processing circuitry 1341, and/or DNS query circuitry 1342, in a particular aspect, or equivalents thereof.

Further at block 1404 the UE may transmit a DNS query associated with an edge computing application to one of the first IP address or the second IP address based on logic residing in a UE. In an aspect, the processes of block 1404 may be implemented by a means for transmitting the DNS query, which may be implemented by processor 1304, communication and processing circuitry 1341, and/or DNS query circuitry 1342, in particular aspects, or equivalents thereof.

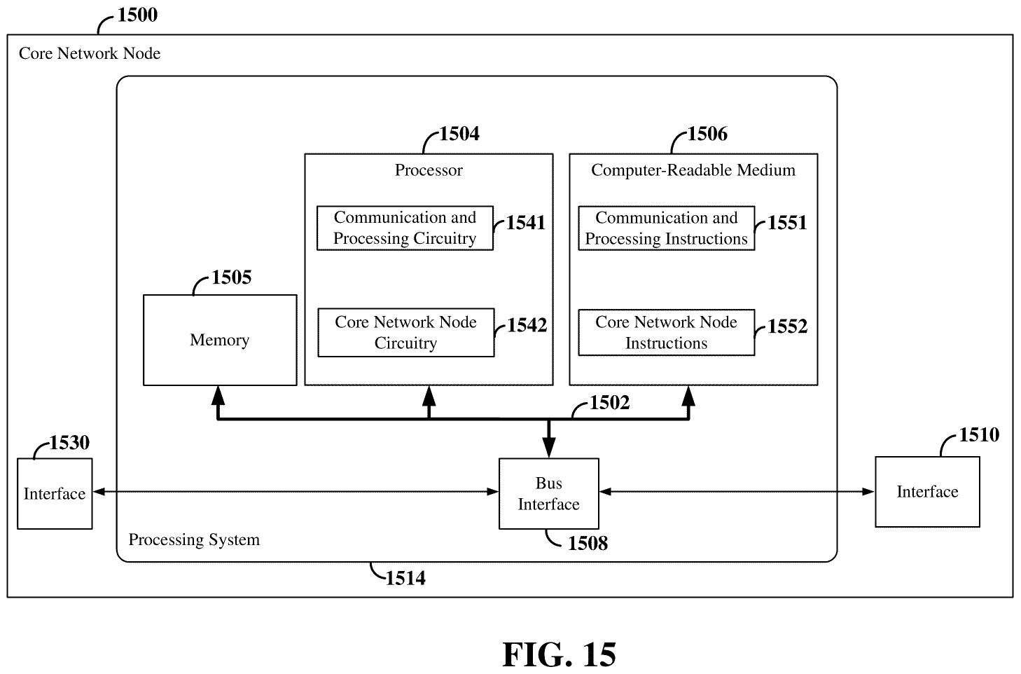

FIG. 15 is a block diagram conceptually illustrating an example of a hardware implementation for a core network node 1500 employing a processing system 1514 according to some aspects of the disclosure. In accordance with various aspects of the disclosure, an element, or any portion of an element, or any combination of elements may be implemented with a processing system 1514 that includes one or more processors 1504. In some implementations, the core network node 1500 may correspond to any of the Home SMF nodes shown in any of the FIGs. included herein.

The core network node 1500 may be implemented with a processing system 1514 that includes one or more processors 1504. Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the core network node 1500 may be configured to perform any one or more of the functions described herein. That is, the processor 1504, as utilized in core network node 1500, may be used to implement any one or more of the processes and procedures described herein.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 communicatively couples together various circuits including one or more processors (represented generally by the processor 1504), a memory 1505, and computer-readable media (represented generally by the computer-readable medium 1506). The bus 1502 may also link various other circuits such as timing sources, peripherals, voltage regulators, and power management circuits, which are well known in the art, and therefore, will not be described any further. A bus interface 1508 provides an interface between the bus 1502 and an interface 1510 and between the bus 1502 and an interface 1530. The interface 1510 provides a communication interface or means for communicating with various other apparatus over a wireless transmission medium. At least one interface 1530 (e.g., a network interface and/or a user interface) provides a communication interface or means of communicating with various other apparatus and devices (e.g., other devices housed within the same apparatus as the core network node 1500 or an external apparatus) over an internal bus or external transmission medium, such as an Ethernet cable.

The processor 1504 is responsible for managing the bus 1502 and general processing, including the execution of software stored on the computer-readable medium 1506. The software, when executed by the processor 1504, causes the processing system 1514 to perform the various functions described below for any particular apparatus. The computer-readable medium 1506 and the memory 1505 may also be used for storing data that is manipulated by the processor 1504 when executing software.

One or more processors 1504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1506.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

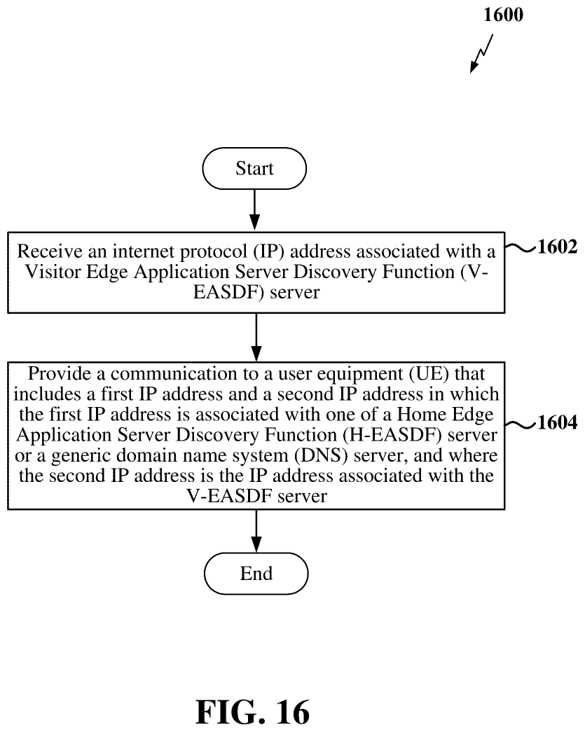

The core network node 1500 may be configured to perform any one or more of the operations described herein (e.g., as described above in conjunction with FIGS. 6-12 and as described below in conjunction with FIG. 16). In some aspects of the disclosure, the processor 1504, as utilized in the core network node 1500, may include circuitry configured for various functions.

The processor 1504 may be configured to generate, schedule, and modify a resource assignment or grant of time-frequency resources (e.g., a set of one or more resource elements). For example, the processor 1504 may schedule time-frequency resources within a plurality of time division duplex (TDD) and/or frequency division duplex (FDD) subframes, slots, and/or mini-slots to carry user data traffic and/or control information to and/or from multiple UEs.

The processor 1504 may include communication and processing circuitry 1541. The communication and processing circuitry 1541 may include one or more hardware components that provide the physical structure that performs various processes related to wireless communication (e.g., signal reception and/or signal transmission) as described herein. The communication and processing circuitry 1541 may further include one or more hardware components that provide the physical structure that performs various processes related to signal processing (e.g., processing a received signal and/or processing a signal for transmission) as described herein. In some examples, the communication and processing circuitry 1541 may include two or more transmit/receive chains. The communication and processing circuitry 1541 may further be configured to execute communication and processing software 1551 included on the computer-readable medium 1506 to implement one or more functions described herein.

The processor 1504 also includes core network node circuitry 1542 configured to perform any of various acts, including for example, receiving DNS queries and subsequently responding to those queries. The core network node circuitry 1542 may further be configured to execute core network node instructions 1552 included on the computer-readable medium 1506 to implement one or more functions described herein.

In further aspects, the processor 1504 in conjunction with the communication and processing circuitry 1541 and/or the core network node circuitry 1542 may be configured to perform various acts. For instance, the processor 1504 in conjunction with the communication and processing circuitry 1541 and/or the core network node circuitry 1542 may be configured to receive an IP address associated with a V-EASDF server; and provide a communication to a UE that includes a first IP address and a second IP address, wherein the first IP address is associated with one of H-EASDF server or a generic DNS server, and wherein the second IP address is the IP address associated with the V-EASDF server.

In another aspect, the processor 1504 in conjunction with the communication and processing circuitry 1541 and/or the core network node circuitry 1542 may be further configured to communicate in various ways to different entities. For instance, in some examples, the processor 1504 in conjunction with the communication and processing circuitry 1541 and/or the core network node circuitry 1542 may be configured to provide the communication to the UE during an establishment of an HR PDU session, wherein the HR PDU session comprises an SBO in a V-PLMN. It is further contemplated that the communication to the UE may be an ePCO communication, wherein the processor 1504 in conjunction with the communication and processing circuitry 1541 and/or the core network node circuitry 1542 may be configured to provide the ePCO communication to the UE via a V-SMF (e.g., where the ePCO communication to the UE further includes a preference indicating which of the first IP address or the second IP address is preferred by a network.

FIG. 16 is a flow chart illustrating an example wireless communication method 1600 according to some aspects of the disclosure. As described herein, some or all illustrated features may be omitted in a particular implementation within the scope of the present disclosure, and some illustrated features may not be required for implementation of all examples. In some examples, the method 1600 may be carried out by the core network node 1500 (e.g., SMF, EASDF, etc.) illustrated in FIG. 15. In some examples, the method 1600 may be carried out by any suitable apparatus or means for carrying out the functions or algorithm described below.

At block 1602, the method 1600 includes receiving an IP address associated with a V-EASDF server. In an aspect, the processes of block 1602 may be implemented by a means for receiving an IP address, which may be implemented by the processor 1504 in conjunction with the communication and processing circuitry 1541, and/or the core network node circuitry 1542, in a particular aspect, or equivalents thereof.

Additionally, in block 1604, method 1600 includes providing a communication to a UE that includes a first IP address and a second IP address in which the first IP address is associated with one of a H-EASDF server or a generic DNS server, and where the second IP address is the IP address associated with the V-EASDF server. In an aspect, the processes of block 1604 may implemented by a means for transmitting a communication to a UE, which may be implemented by the processor 1504 in conjunction with the communication and processing circuitry 1541, and/or the Core network node circuitry 1542, in a particular aspect, or equivalents thereof.

Of further note, the present disclosure may include the following further aspects of the present disclosure.

Aspect 1: A UE, comprising a transceiver; a memory storing instructions; and a processor communicatively coupled to the transceiver and the memory, wherein the processor is configured to: receive a first IP address and a second IP address, wherein the first IP address is associated with one of an H-EASDF server or a generic DNS server, and wherein the second IP address is associated with a V-EASDF server; and transmit a DNS query associated with an edge computing application to one of the first IP address or the second IP address based on the instructions.

Aspect 2: The UE of aspect 1, wherein the processor is further configured to receive a preference indicating which of the first IP address or the second IP address is preferred by a network, and wherein the logic residing on the UE is configured to select one of the first IP address or the second IP address based in part on the preference.

Aspect 3: The UE of either aspect 1 or aspect 2, wherein the instructions are configured to select one of the first IP address or the second IP address based in part on whether the edge computing application is configured to enable edge computing roaming.

Aspect 4: The UE of any of aspects 1 through 3, wherein the instructions are configured to select one of the first IP address or the second IP address based in part on whether the edge computing application indicates a preference to use edge computing roaming.

Aspect 5: The UE of any of aspects 1 through 4, wherein the instructions are configured to select one of the first IP address or the second IP address based in part on load conditions of the UE.

Aspect 6: The UE of aspect 5, wherein the load conditions of the UE include a total number of applications running on the UE.

Aspect 7: The UE of any of aspects 1 through 6, wherein the processor is configured to receive the first IP address and the second IP address within an ePCO communication.

Aspect 8: The UE of aspect 7, wherein the processor is configured to receive the ePCO communication from an H-SMF via a V-SMF.

Aspect 9: The UE of any of aspects 1 through 8, wherein the processor is configured to receive the first IP address and the second IP address during an establishment or a modification of HR PDU session, and wherein the HR PDU session comprises an SBO in a V-PLMN.

Aspect 10: A method for wireless communication in a UE, comprising: receiving a first IP address and a second IP address, wherein the first IP address is associated with one of an H-EASDF server or a generic DNS server, and wherein the second IP address is associated with a V-EASDF server; and transmitting a DNS query associated with an edge computing application to one of the first IP address or the second IP address based on instructions included in a memory of the UE.

Aspect 11: The method of aspect 10, further comprising receiving a preference indicating which of the first IP address or the second IP address is preferred by a network, wherein the instructions are configured to select one of the first IP address or the second IP address based in part on the preference.

Aspect 12: The method of either aspect 10 or aspect 11, further comprising selecting one of the first IP address or the second IP address based in part on whether the edge computing application is configured to enable edge computing roaming.

Aspect 13: The method of any of aspects 10 through 12, further comprising selecting one of the first IP address or the second IP address based in part on whether the edge computing application indicates a preference to use edge computing roaming.

Aspect 14: The method of any of aspects 10 through 13, further comprising selecting one of the first IP address or the second IP address based in part on load conditions of the UE.

Aspect 15: The method of aspect 14, wherein the load conditions of the UE include a total number of applications running on the UE.

Aspect 16: The method of any of aspects 10 through 15, further comprising receiving the first IP address and the second IP address within an ePCO communication.

Aspect 17: The method of aspect 16, further comprising receiving the ePCO communication from an H-SMF via a V-SMF.

Aspect 18: The method of any of aspects 10 through 17, further comprising receiving the first IP address and the second IP address during an establishment or a modification of an HR PDU session, and wherein the HR PDU session comprises an SBO in a V-PLMN.

Aspect 19: A UE, comprising a transceiver; a memory storing instructions; a processor communicatively coupled to the transceiver and the memory; means for receiving a first IP address and a second IP address, wherein the first IP address is associated with one of an H-EASDF server or a generic DNS server, and wherein the second IP address is associated with a V-EASDF server; and means for transmitting a DNS query associated with an edge computing application to one of the first IP address or the second IP address based on the instructions.

Aspect 20: The UE of aspect 19, further comprising means for receiving a preference indicating which of the first IP address or the second IP address is preferred by a network, wherein the instructions are configured to select one of the first IP address or the second IP address based in part on the preference.

Aspect 21: The UE of either aspect 19 or aspect 20, further comprising means for selecting one of the first IP address or the second IP address based in part on whether the edge computing application is configured to enable edge computing roaming.

Aspect 22: The UE of any of aspects 19 through 21, further comprising means for selecting one of the first IP address or the second IP address based in part on whether the edge computing application indicates a preference to use edge computing roaming.

Aspect 23: The UE of any of aspects 19 through 22, further comprising means for selecting one of the first IP address or the second IP address based in part on load conditions of the UE.

Aspect 24: The UE of aspect 23, wherein the load conditions of the UE include a total number of applications running on the UE.

Aspect 25: The UE of any of aspects 19 through 24, further comprising means for receiving the first IP address and the second IP address within an ePCO communication.

Aspect 26: The UE of aspect 25, further comprising means for receiving the ePCO communication from an H-SMF via a V-SMF.

Aspect 27: The UE of any of aspects 19 through 26, further comprising means for receiving the first IP address and the second IP address during an establishment or a modification of an HR PDU session, wherein the HR PDU session comprises an SBO in a V-PLMN.

Aspect 28: A non-transitory computer-readable medium storing computer-executable instructions, the computer-executable instructions configured to cause a computer to: receive a first IP address and a second IP address, wherein the first IP address is associated with one of an H-EASDF server or a generic DNS server, and wherein the second IP address is associated with a V-EASDF server; and transmit a DNS query associated with an edge computing application to one of the first IP address or the second IP address based on the computer-executable instructions.

Aspect 29: The non-transitory computer-readable medium of aspect 28, wherein the computer-executable instructions are further configured to receive a preference indicating which of the first IP address or the second IP address is preferred by a network, and to select one of the first IP address or the second IP address based in part on the preference.

Aspect 30: The non-transitory computer-readable medium of either aspect 28 or aspect 29, wherein the computer-executable instructions are configured to select one of the first IP address or the second IP address based in part on whether the edge computing application is configured to enable edge computing roaming.

Aspect 31: The non-transitory computer-readable medium of any of aspects 28 through 30, wherein the computer-executable instructions are configured to select one of the first IP address or the second IP address based in part on whether the edge computing application indicates a preference to use edge computing roaming.

Aspect 32: The non-transitory computer-readable medium of any of aspects 28 through 31, wherein the computer-executable instructions are configured to select one of the first IP address or the second IP address based in part on load conditions of the UE.

Aspect 33: The non-transitory computer-readable medium of aspect 32, wherein the load conditions of the UE include a total number of applications running on the UE.

Aspect 34: The non-transitory computer-readable medium of any of aspects 28 through 33, wherein the computer-executable instructions are configured to receive the first IP address and the second IP address within an ePCO communication.

Aspect 35: The non-transitory computer-readable medium of aspect 34, wherein the computer-executable instructions are configured to receive the ePCO communication from an H-SMF via a V-SMF.

Aspect 36: The non-transitory computer-readable medium of any of aspects 28 through 35, wherein the computer-executable instructions are configured to receive the first IP address and the second IP address during an establishment or a modification of HR PDU session, and wherein the HR PDU session comprises an SBO in a V-PLMN.

Aspect 37: A core network node within a mobile core network, comprising: a memory storing instructions; and a processor coupled to the memory, the processor being configured to: receive an IP address associated with a V-EASDF server; and provide a communication to a UE that includes a first IP address and a second IP address, wherein the first IP address is associated with one of H-EASDF server or a generic DNS server, and wherein the second IP address is the IP address associated with the V-EASDF server.

Aspect 38: The core network node of aspect 37, wherein the communication to the UE further includes a preference indicating which of the first IP address or the second IP address is preferred by a network.

Aspect 39: The core network node of either of aspect 37 or aspect 38, wherein the communication to the UE is an ePCO communication.

Aspect 40: The core network node of aspect 39, wherein the processor is configured to provide the ePCO communication to the UE via a V-SMF.

Aspect 41: The core network node of any of aspects 37 through 40, wherein the processor is configured to provide the communication to the UE during an establishment or a modification of an HR PDU session.

Aspect 42: The core network node of aspect 41, wherein the HR PDU session comprises an SBO in a V-PLMN.

Aspect 43: A method for wireless communications in a core network node comprising: receiving an IP address associated with a V-EASDF server; and providing a communication to a UE that includes a first IP address and a second IP address, wherein the first IP address is associated with one of H-EASDF server or a generic DNS server, and wherein the second IP address is the IP address associated with the V-EASDF server.

Aspect 44: The method of aspect 43, wherein the communication to the UE further includes a preference indicating which of the first IP address or the second IP address is preferred by a network.

Aspect 45: The method of either of aspect 43 or aspect 44, wherein the communication to the UE is an ePCO communication.

Aspect 46: The method of aspect 45, further comprising providing the ePCO communication to the UE via a V-SMF.

Aspect 47: The method of any of aspects 43 through 46, further comprising providing the communication to the UE during an establishment or a modification of an HR PDU session.

Aspect 48: The method of aspect 47, wherein the HR PDU session comprises an SBO in a V-PLMN.

Aspect 49: A core network node within a mobile core network, comprising: a memory storing instructions; a processor coupled to the memory; means for receiving an IP address associated with a V-EASDF server; and means for providing a communication to a UE that includes a first IP address and a second IP address, wherein the first IP address is associated with one of H-EASDF server or a generic DNS server, and wherein the second IP address is the IP address associated with the V-EASDF server.

Aspect 50: The core network node of aspect 49, wherein the communication to the UE further includes a preference indicating which of the first IP address or the second IP address is preferred by a network.

Aspect 51: The core network node of either of aspect 49 or aspect 50, wherein the communication to the UE is an ePCO communication.

Aspect 52: The core network node of aspect 51, further comprising means for providing the ePCO communication to the UE via a V-SMF.

Aspect 53: The core network node of any of aspects 49 through 52, further comprising means for providing the communication to the UE during an establishment or a modification of an HR PDU session.

Aspect 54: The core network node of any of aspects 50 through 53, further comprising means for providing the communication to the UE during an establishment or a modification of an HR PDU session, wherein the HR PDU session comprises an SBO in a V-PLMN.

Aspect 55: A non-transitory computer-readable medium storing computer-executable instructions, the computer-executable instructions configured to cause a computer to: receive an IP address associated with a V-EASDF server; and provide a communication to a UE that includes a first IP address and a second IP address, wherein the first IP address is associated with one of H-EASDF server or a generic DNS server, and wherein the second IP address is the IP address associated with the V-EASDF server.

Aspect 56: The non-transitory computer-readable medium of aspect 55, wherein the communication to the UE further includes a preference indicating which of the first IP address or the second IP address is preferred by a network.

Aspect 57: The non-transitory computer-readable medium of either of aspect 55 or aspect 56, wherein the communication to the UE is an ePCO communication.

Aspect 58: The non-transitory computer-readable medium of aspect 57, wherein the computer-executable instructions are configured to provide the ePCO communication to the UE via a V-SMF.

Aspect 59: The non-transitory computer-readable medium of any of aspects 55 through 58, wherein the computer-executable instructions are configured to provide the communication to the UE during an establishment or a modification of an HR PDU session.

Aspect 60: The non-transitory computer-readable medium of aspect 59, wherein the HR PDU session comprises an SBO in a V-PLMN.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) standards IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may encompass a wide variety of actions. For example, “determining” may include calculating, computing, processing, deriving, investigating, looking up (e.g., looking up in a table, a database or another data structure), ascertaining, resolving, selecting, choosing, establishing, receiving (e.g., receiving information), accessing (e.g., accessing data in a memory), and the like.

One or more of the components, steps, features and/or functions illustrated in FIGS. 1-16 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in any of FIGS. 1-16 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE), comprising:
a transceiver;
a memory storing instructions; and
a processor coupled to the transceiver and the memory, wherein the processor is configured to:
receive a first internet protocol (IP) address and a second IP address, wherein the first IP address is associated with one of a Home Edge Application Server Discovery Function (H-EASDF) server or a generic domain name system (DNS) server, and wherein the second IP address is associated with a Visitor Edge Application Server Discovery Function (V-EASDF) server; and
transmit a DNS query associated with an edge computing application to one of the first IP address or the second IP address based on the instructions.

2. The UE of claim 1, wherein the processor is further configured to receive a preference indicating which of the first IP address or the second IP address is preferred by a network, and wherein the instructions are configured to select one of the first IP address or the second IP address based in part on the preference.

3. The UE of claim 1, wherein the instructions are configured to select one of the first IP address or the second IP address based in part on whether the edge computing application is configured to enable edge computing roaming.

4. The UE of claim 1, wherein the instructions are configured to select one of the first IP address or the second IP address based in part on whether the edge computing application indicates a preference to use edge computing roaming.

5. The UE of claim 1, wherein the instructions are configured to select one of the first IP address or the second IP address based in part on load conditions of the UE.

6. The UE of claim 5, wherein the load conditions of the UE include a total number of applications running on the UE.

7. The UE of claim 1, wherein the processor is configured to receive the first IP address and the second IP address within an Extended Protocol Configuration Options (ePCO) communication.

8. The UE of claim 7, wherein the processor is configured to receive the ePCO communication from a Home Session Management Function (H-SMF) via a Visited Session Management Function (V-SMF).

9. The UE of claim 1, wherein the processor is configured to receive the first IP address and the second IP address during an establishment or a modification of a home routed (HR) protocol data unit (PDU) session, and wherein the HR PDU session comprises a session breakout (SBO) in a Visited Public Land Mobile Network (V-PLMN).

10. A method for wireless communication in a user equipment (UE), comprising:
receiving a first internet protocol (IP) address and a second IP address, wherein the first IP address is associated with one of a Home Edge Application Server Discovery Function (H-EASDF) server or a generic domain name system (DNS) server, and wherein the second IP address is associated with a Visitor Edge Application Server Discovery Function (V-EASDF) server; and
transmitting a DNS query associated with an edge computing application to one of the first IP address or the second IP address based on instructions included in a memory of the UE.

11. The method of claim 10, further comprising receiving a preference indicating which of the first IP address or the second IP address is preferred by a network, wherein the instructions are configured to select one of the first IP address or the second IP address based in part on the preference.

12. The method of claim 10, further comprising selecting one of the first IP address or the second IP address based in part on whether the edge computing application is configured to enable edge computing roaming.

13. The method of claim 10, further comprising selecting one of the first IP address or the second IP address based in part on whether the edge computing application indicates a preference to use edge computing roaming.

14. The method of claim 10, further comprising selecting one of the first IP address or the second IP address based in part on load conditions of the UE.

15. The method of claim 14, wherein the load conditions of the UE include a total number of applications running on the UE.

16. The method of claim 10, further comprising receiving the first IP address and the second IP address within an Extended Protocol Configuration Options (ePCO) communication.

17. The method of claim 16, further comprising receiving the ePCO communication from a Home Session Management Function (H-SMF) via a Visited Session Management Function (V-SMF).

18. The method of claim 10, further comprising receiving the first IP address and the second IP address during an establishment or a modification of a home routed (HR) protocol data unit (PDU) session, and wherein the HR PDU session comprises a session breakout (SBO) in a Visited Public Land Mobile Network (V-PLMN).

19. A core network node within a mobile core network, comprising:
a memory storing instructions; and
a processor coupled to the memory, the processor being configured to:
receive an internet protocol (IP) address associated with a Visitor Edge Application Server Discovery Function (V-EASDF) server; and
provide a communication to a user equipment (UE) that includes a first IP address and a second IP address, wherein the first IP address is associated with one of a Home Edge Application Server Discovery Function (H-EASDF) server or a generic domain name system (DNS) server, and wherein the second IP address is the IP address associated with the V-EASDF server.

20. The core network node of claim 19, wherein the communication to the UE further includes a preference indicating which of the first IP address or the second IP address is preferred by a network.

21. The core network node of claim 19, wherein the communication to the UE is an Extended Protocol Configuration Options (ePCO) communication.

22. The core network node of claim 21, wherein the processor is configured to transmit the ePCO communication to the UE via a Visited Session Management Function (V-SMF).

23. The core network node of claim 19, wherein the processor is configured to provide the communication to the UE during an establishment or a modification of a home routed (HR) protocol data unit (PDU) session.

24. The core network node of claim 23, wherein the HR PDU session comprises a session breakout (SBO) in a Visited Public Land Mobile Network (V-PLMN).

25. A method for wireless communications in a core network node comprising:
receiving an internet protocol (IP) address associated with a Visitor Edge Application Server Discovery Function (V-EASDF) server; and
providing a communication to a user equipment (UE) that includes a first IP address and a second IP address, wherein the first IP address is associated with one of a Home Edge Application Server Discovery Function (H-EASDF) server or a generic domain name system (DNS) server, and wherein the second IP address is the IP address associated with the V-EASDF server.

26. The method of claim 25, wherein the communication to the UE further includes a preference indicating which of the first IP address or the second IP address is preferred by a network.

27. The method of claim 25, wherein the communication to the UE is an Extended Protocol Configuration Options (ePCO) communication.

28. The method of claim 27, further comprising providing the ePCO communication to the UE via a Visited Session Management Function (V-SMF).

29. The method of claim 25, further comprising providing the communication to the UE during an establishment or a modification of a home routed (HR) protocol data unit (PDU) session.

30. The method of claim 29, wherein the HR PDU session comprises a session breakout (SBO) in a Visited Public Land Mobile Network (V-PLMN).
